(19) United States
(12) Patent Application Publication
(10) Pub. No.: US 2014/0033105 A1
(43) Pub. Date: Jan. 30, 2014

(54) CONTROL SYSTEM AND METHOD THEREOF

(71) Applicant: HON HAI PRECISION INDUSTRY CO., LTD., New Taipei (TW)

(72) Inventors: HONG-SHENG CHEN, New Taipei (TW); WEN-HUI CHANG, New Taipei (TW); WEI-CHIEH CHAN, New Taipei (TW); CHING-CHANG LIN, New Taipei (TW); CHICH-JANE CHAO, New Taipei (TW); MING-YANG CHENG, New Taipei (TW)

(73) Assignee: HON HAI PRECISION INDUSTRY CO., LTD., New Taipei (TW)

(21) Appl. No.: 13/866,004

(22) Filed: Apr. 18, 2013

(30) Foreign Application Priority Data
Jul. 30, 2012 (TW) 101127527

(51) Int. Cl. G06F 3/0484

(52) U.S. Cl. CPC G06F 3/0484
USPC 715/771

(57) ABSTRACT

A control system for displaying a corresponding control interfaces on a control device based on different external devices comprises storage with a plurality of control interfaces corresponding to different external devices in one-to-one relationship, a searching module, a communicating module, a displaying module, and a selecting module. The searching module searches external devices matched with the control device in a predetermined range around the control device. The communicating module obtains feature information from the matched external devices in response to the communicating signal. The displaying module extracts and displays the obtained feature information. The selecting module selects one of matched external devices as an object device based on the displayed feature information. The display module further extracts and displays the control interface corresponding to the object device for controlling the object device.

### BACKGROUND

1. Technical Field

The present disclosure relates to control systems, particularly, to a control system for displaying different control interfaces on a control device to control different external devices.

2. Description of Related Art

Remote controls for different kinds of electronic devices, such as televisions or air conditions, cannot be interchanged. For example, the remote control for the television can not control the air conditioner. Therefore, the users may have many remote controls to control the different kinds of electronic devices. However, an operator may carelessly select a remote control, which is not matched with the expected electronic device causing inconvenience. Further, having many remote controls may cause clutter and occupy space.

Therefore, there is room for improvement in the art.

### BRIEF DESCRIPTION OF THE FIGURE

Many aspects of the embodiments can be better understood with reference to the following drawings. The components in the drawings are not necessarily drawn to scale, the emphasis instead being placed upon clearly illustrating the principles of the control system and method thereof. Moreover, in the drawings, like reference numerals designate corresponding parts throughout the several views.

FIG. 1 is a block diagram of a control system in accordance with an embodiment.

FIG. 2 is a schematic diagram showing an operation interface of the control system of FIG. 1.

FIG. 3 is a schematic diagram showing a control interface in accordance with the embodiment.

FIG. 4 is a schematic diagram showing another control interface in accordance with the embodiment.

FIG. 5 is a flowchart of a control method in accordance with the embodiment.

### DETAILED DESCRIPTION

In general, the word “module,” as used herein, refers to logic embodied in hardware or firmware, or to a collection of software instructions, written in a programming language, for example, Java, C, or assembly. One or more software instructions in the modules may be embedded in firmware, such as in an EPROM. Modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage system. Embodiments of the present disclosure will be described with reference to the drawings.

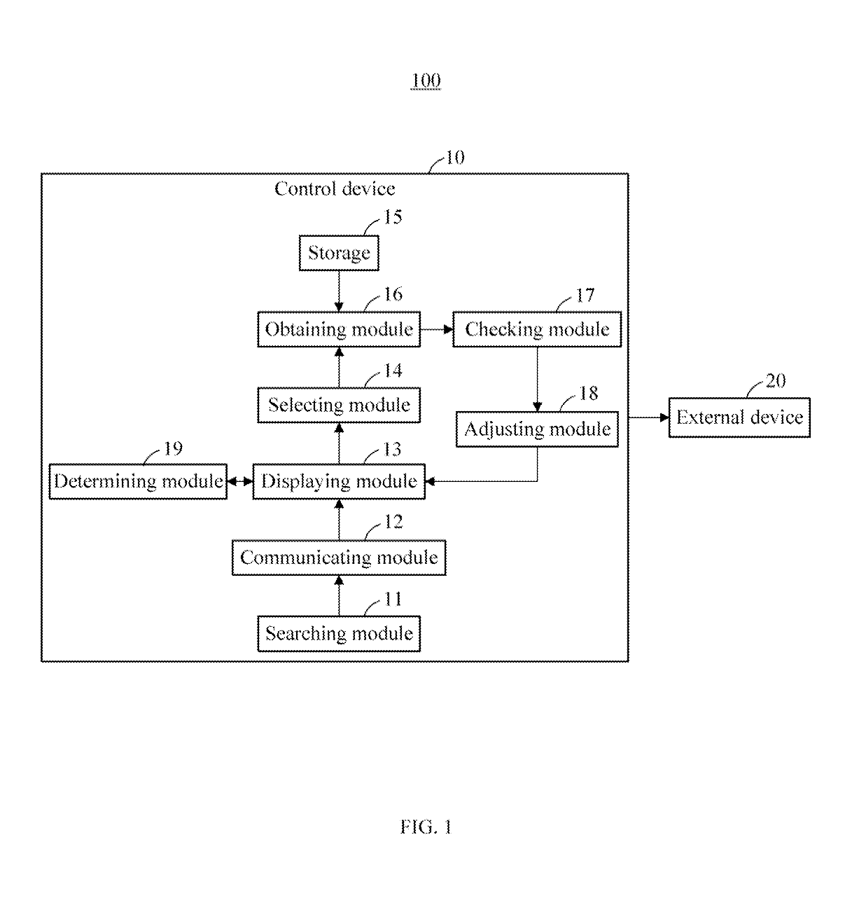

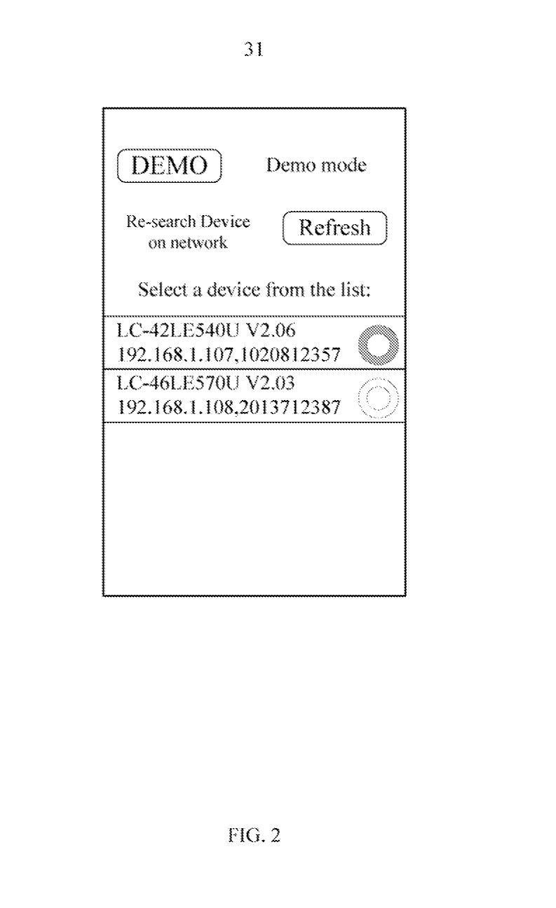

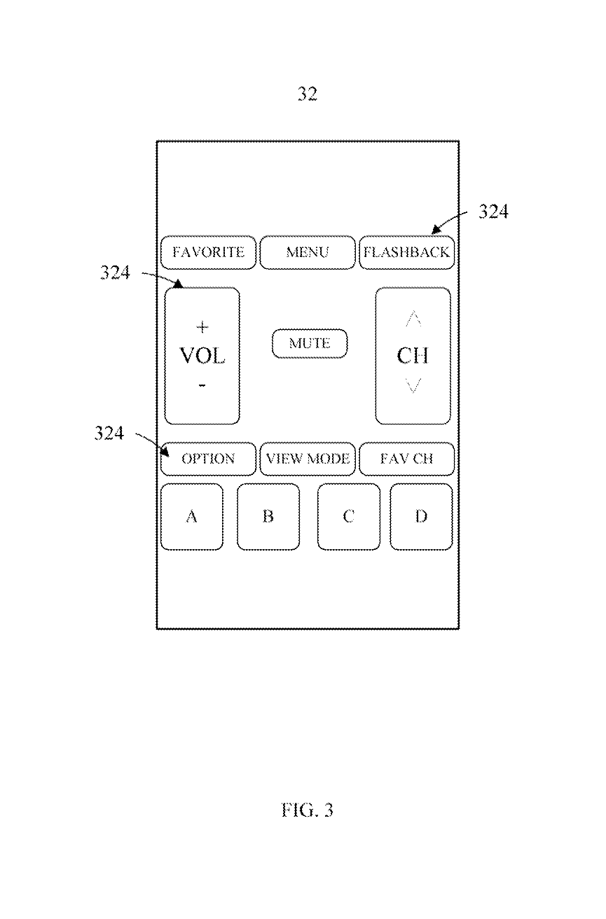

FIGS. 1 and 2 show a control system 100 of the embodiment. The control system 100 includes a control device 10 and an external device 20. The control device 10 is capable of establishing different control interfaces 32 (as shown in FIG. 3) to control different external devices 20. In the embodiment, the control device 10 is a mobile phone; the external devices 20 are televisions. In other embodiment, some of the external devices 20 can be air conditioners, or DVD players.

The control device 10 includes a searching module 11, a communicating module 12, a displaying module 13, a selecting module 14, storage 15, an obtaining module 16, a checking module 17, an adjusting module 18, and a determining module 19.

The searching module 11 searches external devices 20 matched with the control device 10 in a predetermined range around the control device 10, and obtains feature information from the searched external device 20 in a predetermined format via the communication module 12. In the embodiment, the control device 10 searches external devices 20 via BLUETOOTH protocols. In the predetermined format, the feature information is divided into several segments based on different functions, and the segment can further be divided into several parts. Each of the segments ends with a first delimiter for distinguishing the two adjacent segments. A second delimiter is arranged between two adjacent parts for distinguishing the two adjacent parts. The length of segments can be different from each other. For example, the feature information obtained from the matched external device 20 is “SPRC#DISC#16#1#6#192.168.1.24|IPPROTO_TCP|16687|LC-42LE540U|V2.06|1 020812357#”. The first delimiter is “#”, and the second delimiter is “|”. The first segment of “SPRC” is servo information. The second segment of “DISC” is a type of the action instruction. The third segment of “16” is a group ID. The fourth segment of “1” is position information. The fifth segment of “6” is a total number of the parts contained in the sixth segment. The first part “192.168.1.24” of the sixth segment is an IP address. The second part “IPPROTO_TCP” of the sixth segment is a transmitting protocol. The third part “16687” of the sixth segment is a port number. The fourth part “LC-42LE540U” of the sixth segment is the product model of the external device 20. The fifth part “V2.06” of the sixth segment is the edition of the external device 20. The sixth part “1020812357” of the sixth segment is the serial number of the external device 20.

The displaying module 13 extracts and displays the obtained feature information of the searched external devices 20. In the embodiment, the displaying module 13 is a touch panel, and each obtained feature information of the external devices 20 are partly extracted, and are arranged in rows at an operation interface 31 (as shown in FIG. 2).

The selecting module 14 selects one of the matched external devices 20 as an object device based on the displayed feature information.

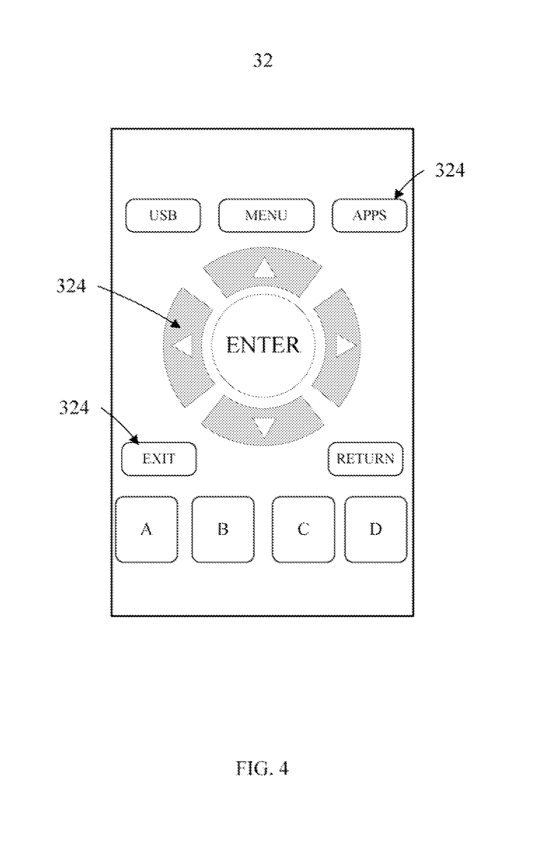

The storage 15 stores a plurality of control interfaces 32 corresponding to a plurality of product models in a one-to-one relationship The control interface 32 includes a plurality of different function keys 324. The storage 15 further stores a plurality of sub-interfaces. Parts of the keys 324 are associated with the sub-interfaces in one-to-one relationship; and the rest of the keys 324 are associated with a corresponding control signal. In the embodiment, the control interface 32 in FIG. 3 corresponds to the external device 20 with the product model “LC-42LE540U”, the control interface 32 in FIG. 4 corresponds to the external device 20 with the product module “LC-46LE570U”.

The obtaining module 16 obtains a control interface 32 from the storage 15 based on the object device and generates a checking signal. In the embodiment, the obtaining module 16 obtains the control interface 32 based on the product model of the object device.

The checking module 17 orderly checks whether all the functions in the obtained control interface 32 exists in the object device in response to the checking signal, and generates an adjusting signal when one of the functions in the obtained control interface 32 does not exist in the object device. In the embodiment, the external device 20 with the same product model may have different functions based on the other parameters, such as different editions.

The adjusting module 18 adjusts the control interface 32 in response to the adjusting signal and generates a first signal. In the embodiment, the adjusting module 18 disables the key 324 corresponding to the function which does not exist in the object device. In the embodiment, the adjusting module 18 can hide the key 324 corresponding to the function which does not exist in the object device.

The displaying module 13 further displays the obtained control interface 32 corresponding to the object device in response to the first signal.

The determining module 19 determines whether there is a sub-interface associated with the pressed key 324. If there is a sub-interface associated with the pressed key 324, the determining module 19 generates a second signal. If there is no sub-interface associated with the pressed key 324, the determining module 19 generates a control signal corresponding to the pressed key 324.

The displaying module further extracts and displays the sub-interface corresponding to the pressed key 324 in response to the second signal.

The communicating module 12 further transmits the control signal for controlling the object device to execute a corresponding function. In the embodiment, the control signal may control the object to increase volume or change the song, for example.

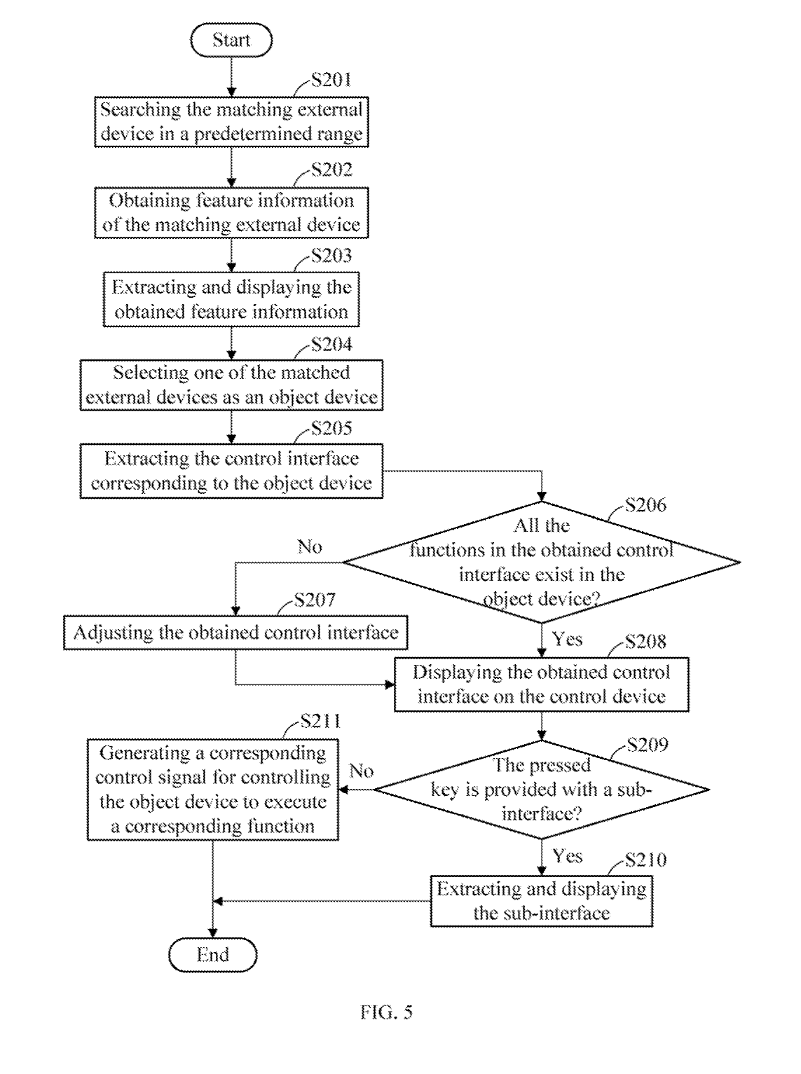

FIG. 5 shows that a control method for establishing different control interfaces 32 (as shown in FIG. 3) on a control device 10 to control different external devices 20. The control device 10 stores a plurality of different control interfaces 32 corresponding to different external devices 20 in one-to-one relationship based on the product model and a plurality of sub-interface associated with a part of the keys in one-to-one relationship. In the embodiment, the control device 10 is a mobile phone; the external device 20 is a television. The control method includes the following steps.

In step S201, searching of the electronic device 20 matches with the control device 10 in a predetermined range around the control device 10. In the embodiment, the control device 10 searches external devices 20 via BLUETOOTH protocols.

In step S202, obtaining feature information from the matched external devices 20 in a predetermined format. In the embodiment, the feature information includes servo information, type of the action instruction, group ID, position information, IP address, parameter of the matched external device 20, for example.

In step S203, extracting and displaying the obtained feature information of the searched external devices 20. In the embodiment, the displaying module 13 is a touch panel, and each obtained feature information of the external devices 20 are partly extracted, and are arranged in rows at an operation interface 31 (as shown in FIG. 2).

In step S204, selecting one of the matched external devices 20 as an object device based on the displayed feature information.

In step S205, obtaining the control interface 32 corresponding to the object device from the storage. In the embodiment, the control interface 32 includes a plurality of different function keys 324 for generating a corresponding control signal or a sub-interface when being pressed.

In step S206, checking whether all the functions in the obtained control interface 32 exist in the object device. If some of the functions in the obtained control interface 32 do not exist in the object device, the procedure goes to S207; if all functions in the obtained control interface 32 exist in the object device, the procedure goes to S208.

In step S207, adjusting the control interface 32. In the embodiment, the adjusting module 18 disables the keys 324 corresponding to the function which do not exist in the object device. In the embodiment, the adjusting module 18 can hide the keys 324 corresponding to the functions which do not exist in the object device.

In step S208, displaying the control interface 32 on the control device 10.

In step S209, determining whether there is a sub-interface associated with the pressed key 324. If there is a sub-interface associated with the pressed key 324, the procedure goes to S210; if the there is no sub-interface associated with the pressed key 324, the procedure goes to S211.

In step S210, extracting and displaying the sub-interface corresponding to the pressed key on the control device 10, the procedure ends.

In step S211, generating a corresponding control signal for controlling the object device to execute a corresponding function. In the embodiment, the control signal may control the object to increase volume or change the song, for example.

In use, the control device 10 can be matched with different external devices 20 and establishes a corresponding control interface based on the chosen external device 20 for controlling the chosen external device 20 to execute different function, such that the amount of remote controls for different external devices 20 is reduced.

While various exemplary embodiments have been described, the disclosure is not to be limited thereto. Various modifications and similar arrangements (as would be apparent to those skilled in the art) are also intended to be covered. Therefore, the scope of the appended claims should be accorded the broadest interpretation so as to encompass all such modifications and similar arrangements.

What is claimed is:

1. A control system for displaying a control interface on a control device based on different external devices; the control system comprising:
a storage with a plurality of control interfaces corresponding to different external devices in one-to-one relationship;
a searching module configured to search external devices matched with the control device in a predetermined range around the control device;
a communicating module configured to obtain feature information from the matched external devices in response to the communicating signal;
a displaying module configured to extract and display the obtained feature information; and
a selecting module configured to select one of the matched external devices as an object device based on the displayed feature information;
wherein the display module further displays the control interface in the storage corresponding to the object device for control the object device.

2. The control system of claim 1, wherein the control system further comprises an obtaining module, a checking module, and an adjusting module; the selecting module further generates a first signal; the obtaining module extracts the control interface corresponding to the object device; the checking module orderly checks whether all the functions in the obtained control interface exist in the object device, when some of the functions in the obtained control interface do not exist in the object device, the checking module generates an adjusting signal; the adjusting module adjusts the control interface in response to the adjusting signal.

3. The control system of claim 2, wherein the adjusting module disable the keys corresponding to the functions which do not exist in the object device.

4. The control system of claim 1, wherein the control system further comprises a determining module; the control interface comprises a plurality of keys; the storage further stores a plurality of sub-interface associated with a parts of the keys in one-to-one relationship; when one of the key is being pressed, the determining module determines whether there is a sub-interface associated with the pressed key, when there is a sub-interface associated with the pressed key, the determining module generates a second signal, and the displaying module extracts and displays the obtained sub-interface corresponding to the pressed key in response to the second signal.

5. The control system of claim 4, wherein when there is no sub-interface associated with the pressed key, the determining module generates a control signal corresponding to the pressed key for controlling the object device to execute a corresponding function; the communicating module further transmits the control signal to the object device.

6. The control system of claim 1, wherein the feature information is divided into several segments based on different functions, each of the segments ends with a first delimiter for spacing the two adjacent segments, the length of segments can be different from each other.

7. The control system of claim 6, wherein the segment further divide into several parts, a second delimiter is set between two adjacent parts for spacing each other.

8. The control system of claim 1, wherein the control device searches the external devices via BLUETOOTH protocols.

9. A control device capable of displaying a corresponding control interface based on different external devices, the control device comprising:
a storage with a plurality of control interfaces corresponding to different external devices in one-to-one relationship;
a searching module configured to search the external devices matched with the control device in a predetermined range around the control device;
a communicating module configured to obtain feature information from the matched external devices in response to the communicating signal;
a displaying module configured to display all the obtained feature information; and
a selecting module configured to select one of the matched external devices as an object device based on the displayed feature information;
wherein the display module further displays the control interface corresponding to the object device for controlling the object device.

10. The control device of claim 9, wherein the control device further comprises an obtaining module, a checking module, and an adjusting module; the selecting module further generates a first signal; the obtaining module extracts the control interface corresponding to the object device; the checking module orderly checks whether all the functions in the obtained control interface exist in the object device, when some of the functions in the obtained control interface do not exist in the object device, the checking module generates an adjusting signal; the adjusting module adjusts the control interface in response to the adjusting signal.

11. The control device of claim 10, wherein the adjusting module disable the keys corresponding to the functions which do not exist in the object device.

12. The control device of claim 9, wherein the control device further comprises a determining module; the control interface comprises a plurality of keys; the storage further stores a plurality of sub-interface associated with a parts of the keys in one-to-one relationship; when one of the key is being pressed, the determining module determines whether there is a sub-interface associated with the pressed key, when there is a sub-interface associated with the pressed key, the determining module generates a second signal, and the displaying module extracts and displays the obtained sub-interface in response to the second signal.

13. The control device of claim 12, wherein when there is no sub-interface associated with the pressed key, the determining module generates a control signal corresponding to the pressed key for controlling the object device to execute a corresponding function; the communicating module further transmits the control signal to the object device.

14. The control device of claim 9, wherein the control device searches the external devices via BLUETOOTH protocols.

15. A control method for displaying a corresponding control interface on a control device based on different external devices, the control device stores a plurality of control interfaces corresponding to different external devices in one-to-one relationship, the control method comprising:
searching the external devices matched with the control device in a predetermined range around the control device;
obtaining feature information of the matched external devices;
displaying the obtained feature information on the control device;
selecting one of the matched external device as an object device based on the displayed feature information;
extracting and displaying the control interface corresponding to the object device for controlling the object device.

16. The method according to claim 15, after the step of selecting one of the matched external device as an object device based on the displayed feature information further comprising:
checking whether all the functions in the obtained control interface exist in the object device orderly;
extracting and displaying the control interface corresponding to the object device on the control device when all the functions in the obtained control interface exist in the object device.

17. The method according to claim 16, wherein when one of the functions in the obtained control interface does not exist in the object device, adjusting the control interface.

18. The method according to claim 17, wherein the key corresponding to the function which does not exist in the object device is being disabled.

19. The method according to claim 15, wherein control interface comprises a plurality of keys; the control device further stores a plurality of sub-interface associated with a parts of the keys in one-to-one relationship, after the step of displaying the obtained control interface on the control device further comprising:
determining whether there is a sub-interface associated with the pressed key;
generating a corresponding control signal for controlling the object device to execute a corresponding function when there is a sub-interface associated with the pressed key.

20. The method according to claim 19, wherein when there is no sub-interface associated with the pressed key, extracting and displaying the sub-interface corresponding to the pressed key on the control device.
